(19) United States
(12) Patent Application Publication
(10) Pub. No.: US 2023/0281699 A1
(43) Pub. Date: Sep. 7, 2023

(54) BUSINESS OPPORTUNITY INFORMATION SALES SYSTEM AND METHOD THEREOF

(71) Applicant: ENTERPRISE BLOCKCHAIN CO., LTD., Seoul (KR)

(72) Inventors: Jinmo JUNG, Seoul (KR); Jungum KIM, Seoul (KR); Taeho GWAK, Seoul (KR); Junsup LEE, Seoul (KR); Jihyun LEE, Yongin-si (KR); Seonghyuck YOO, Seoul (KR); Sangbae YUN, Seongnam-si (KR)

(73) Assignee: ENTERPRISE BLOCKCHAIN CO., LTD., Seoul (KR)

(21) Appl. No.: 18/016,712

(22) PCT Filed: Jul. 6, 2021
(86) PCT No.: PCT/KR2021/008551

§ 371 Date: Jan. 18, 2023

(30) Foreign Application Priority Data
Jul. 20, 2020 (KR) 10-2020-0089474

(51) Int. Cl. G06Q 30/0601

(52) U.S. Cl. CPC G06Q 30/0637

(57) ABSTRACT

Disclosed are a business opportunity information sales system and a method thereof, the system comprising: a lead sales application including a registration unit for temporarily registering a lead, which is product- or service-related business opportunity information for a customer, on the basis of an external input from a lead seller, and a sales unit for receiving as an input of a purchase request for a purchase lead among at least one predetermined lead provided from a lead management server, on the basis of an external input from a predetermined lead purchaser; and the lead management server including a registration unit for registering the lead obtained from the lead sales application in a database, and a sales unit for providing the least one predetermined lead in the database to the lead sales application so as to be output to the predetermined lead purchaser.

### TECHNICAL FIELD

The present disclosure relates to a business opportunity information sales system and a method therefor, and more particularly, to the business opportunity information sales system and the method for obtaining and registering a lead, which is business opportunity information related to a product or service for a customer, from a lead seller, purchasing a certain lead (purchase lead) from among the registered leads, and confirming selling of the product or service related to the purchase lead.

### BACKGROUND ART

Recently, due to transition to the digital age and concerns about various disease infection caused by viruses or the like, the transition to a so-called untact, non-face-to-face society is accelerating in which almost all aspects of daily life are carried on in such a untact manner.

In such a situation, a salesperson will have limited opportunities to face customers, and thus, it will take a lot of effort, time, and cost to secure any customers. Further, it may not be so much guaranteed for a salesperson to have his/her customers sign a contract to sell a corresponding product or service to the customer.

In the midst of this limited opportunity to face customers, a salesperson often obtains business opportunity information about a customer's purchasing needs associated with other products or services other than the products or services he or she mainly handles from the customer during a consultation with the customer. In such a case, the business opportunity information might be very valuable to other salespersons handling other products or services. However, it would be more or less difficult for the salesperson who acquired the business opportunity information to share the corresponding business opportunity information with another salesperson who handles other products or services through a system, and for the other salespersons to acquire that business opportunity information through the system.

### DETAILED DESCRIPTION OF THE INVENTION

### Technical Problem

The present invention has been devised to cope with the above-described technical problems, and aims to substantially supplement various problems caused by limitations and disadvantages in the prior art. It is therefore an object of the present invention to provide a business opportunity information sales system and a method for obtaining and registering a lead, which is business opportunity information related to a product or service for a customer, from a lead seller, purchasing a specific lead (purchase lead) from among the registered leads, and determining selling of the product or service related to the purchase lead. Further, it is another object of the invention to provide a computer-readable recording medium having recorded thereon a program for executing the method.

### Technical Solution

According to an embodiment of the disclosure, a method for selling business opportunity information comprises: temporarily registering, by a lead sales application, a lead, which is business opportunity information related to a product or service for a customer, based on an external input from a lead seller; registering, by a lead management server, the lead obtained from the lead sales application in a database; providing, by the lead management server, at least one predetermined lead in the database to the lead sales application so as to be output to a predetermined lead purchaser; and receiving, by the lead sales application, a purchase request for a purchase lead of the at least one predetermined lead, based on an external input from the predetermined lead purchaser.

According to an embodiment of the disclosure, the lead may include at least one information of lead type, detailed information for each lead type, customer name, customer age, customer gender, customer marital status, customer address, customer phone number, customer desired contact time, customer budget, customer purchase intention level, or customer expected purchase time.

According to an embodiment of the disclosure, the method for selling business opportunity information further comprises receiving, by the lead sales application, sell completion of the product or service related to the purchase lead, based on an external input from the predetermined lead purchaser; requesting, by the lead sales application, a customer terminal to confirm the selling of the product or service related to the purchase lead; obtaining, by the lead management server, the confirmation of selling of the product or service related to the purchase lead from the customer terminal, based on an external input from the customer; and registering the confirmation of selling for the product or service related to the purchase lead, in the database.

According to an embodiment of the disclosure, temporarily registering the lead further comprises receiving, by the lead sales application, the lead related to a product or service for a customer, based on an external input from the lead seller; and obtaining, by the lead sales application, consent for personal information registration of the customer from the customer terminal, based on an external input from the customer related to the lead.

According to an embodiment of the disclosure, registering the lead in the database further comprises identifying validity of the lead; and obtaining registration approval for the lead from the customer terminal, based on an external input from the customer related to the lead.

According to an embodiment of the disclosure, the at least one predetermined lead further includes at least one of a lead matched based on at least one information of the lead and at least one information of the predetermined lead purchaser or a lead classified based on the at least one information of the lead.

According to an embodiment of the disclosure, providing the at least one predetermined lead in the database to the lead sales application includes further providing a lead price for the at least one predetermined lead and an expected purchase rate of a product or service of a customer for the predetermined lead purchaser, to the lead sales application.

According to an embodiment of the disclosure, the method for selling business opportunity information further comprises completing, by the lead sales application, the purchase for the purchase request, wherein completing the purchase further includes receiving, by the lead sales application, a purchase approval for the purchase lead, based on an external input from the lead seller for the purchase lead; outputting, by the lead sales application, a payment of a predetermined amount of a purchase amount for the purchase lead to a lead seller account; and outputting entire information on the purchase lead to the predetermined lead purchaser.

According to an embodiment of the disclosure, the confirmation of selling further includes at least one of evaluation information on the product or service related to the purchase lead, evaluation information on the predetermined lead purchaser, or evaluation information on the lead seller for the purchase lead.

Further, according to an embodiment of the disclosure, there is provided a computer-readable recording medium having recorded thereon a program for performing the method.

According to an embodiment of the disclosure, a business opportunity information sales system comprises: a lead sales application including a registration module for temporarily registering a lead, which is business opportunity information related to a product or a service for a customer, based on an external input from a lead seller, and a sales module for receiving a purchase request for a purchase lead of at least one predetermined lead provided from a lead management server, based on an external input from a predetermined lead purchaser; and the lead management server including a registration module for registering the lead obtained from the lead sales application in a database, and a sales module for providing the at least one predetermined lead in the database to the lead sales application so as to output the lead to the predetermined lead purchaser.

According to an embodiment of the disclosure, the lead includes at least one information of lead type, detailed information for each lead type, customer name, customer age, customer gender, customer marital status, customer address, customer phone number, customer desired contact time, customer budget, customer purchase intention level, or customer expected purchase time.

According to an embodiment of the disclosure, the lead sales application further includes a sales completion module for receiving a sell completion for the product or service related to the purchase lead, based on an external input from the predetermined lead purchaser and for requesting a sell confirmation for the product or service related to the purchase lead from the customer terminal, and the lead management server further includes a sales completion module for obtaining the sell confirmation for the product or service related to the purchase lead from the customer terminal, based on an external input from the customer and for registering the sell confirmation for the product or service related to the purchase lead in the database.

According to an embodiment of the disclosure, the registration module of the lead sales application receives the lead related to a product or service for a customer, based on an external input from the lead seller, and obtains consent for personal information registration of the customer from the customer terminal, based on an external input from the customer related to the lead.

According to an embodiment of the disclosure, the registration module of the lead management server checks validity of the lead, and obtains registration approval for the lead from the customer terminal, based on an external input from the customer related the lead.

According to an embodiment of the disclosure, the at least one predetermined lead includes at least one of a lead matched based on at least one information of the lead and at least one information of the predetermined lead purchaser or a lead classified based on at least one information of the lead.

According to an embodiment of the disclosure, the sales module of the lead management server further provides a lead price for the at least one predetermined lead and an expected purchase rate of a product or service of a customer for the predetermined lead purchaser, to the lead sales application.

According to an embodiment of the disclosure, the sales module of the lead sales application receives purchase approval for the purchase lead, based on an external input from the lead seller for the purchase lead, outputs payment of a predetermined amount of a purchase amount for the purchase lead to a lead seller account, and outputs entire information on the purchase lead to the predetermined lead purchaser.

According to an embodiment of the disclosure, the sell confirmation further includes at least one of evaluation information on the product or service related to the purchase lead, evaluation information on the predetermined lead purchaser, and evaluation information on the lead seller about the purchase lead.

### Advantageous Effects

According to the present disclosure, when a salesperson acquires business opportunity information (lead) regarding possible purchase needs of a customer related to products or services other than the products or services handled by the salesperson himself or herself through consultation with the customer, the salesperson (lead seller) who acquired the business opportunity information may share the business opportunity information with other salesperson (lead purchaser) who handles the other products or services through the business opportunity information sales system, and the other salesperson may acquire the business opportunity information through the business opportunity information sales system.

Accordingly, according to the disclosure, even when a customer provided some information to a salesperson during consultation, the customer may be provided with detailed information on a product or service from another salesperson professionally dealing with the product or service, through a simple procedure of registering and approving the information on the product or service that he or she may need at a certain time point in his/her life cycle, so that it can be used to make a purchase decision for the product or service in a time-efficient manner.

Further, according to the disclosure, a lead seller may share, through a business opportunity information sales system, business opportunity information on possible purchase needs of customers related to products or services other than the products or services mainly handled by the lead seller, thereby adding value to the business opportunity information and being possibly compensated for the business consulting activities and efforts he/she has put in.

Furthermore, according to the disclosure, a lead buyer may secure business opportunities related to the products or services, by means of purchasing business opportunity information identified from the customers, without unnecessarily spending much effort, time, and cost to secure such customers more.

### BRIEF DESCRIPTION OF THE DRAWINGS

FIG. 1 is a schematic block diagram of a business opportunity information sales system according to an embodiment of the disclosure.

FIG. 2 schematically illustrates a procedure of obtaining and registering a lead from a lead seller in a business opportunity information sales method according to an embodiment of the disclosure.

FIG. 3 schematically illustrates a procedure of a lead purchaser purchasing a lead in a business opportunity information sales method according to an embodiment of the disclosure.

FIG. 4 schematically illustrates a procedure for completing and confirming selling of a corresponding product or service to a customer related to a purchase lead in a business opportunity information sales method according to an embodiment of the disclosure.

FIG. 5 is a schematic block diagram of a lead sales application according to an embodiment of the disclosure.

FIG. 6 is a schematic block diagram of a lead management server according to an embodiment of the disclosure.

### MODE FOR CARRYING OUT THE INVENTION

Hereinafter, preferred embodiments of the disclosure will be described in detail with reference to the accompanying drawings. Throughout the drawings, like or same reference numerals refer to like or same elements and a size of each element may be exaggerated or reduced for better clarity of description.

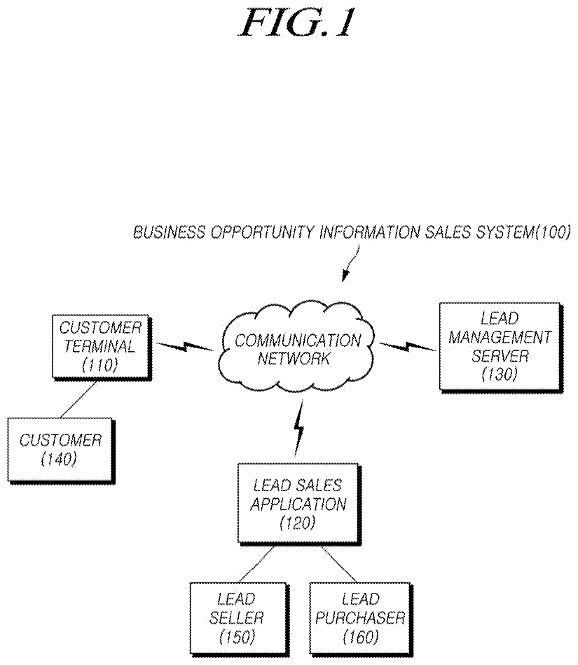

FIG. 1 is a schematic block diagram of a business opportunity information sales system according to an embodiment of the disclosure.

A business opportunity information sales system 100 according to an embodiment of the disclosure may include a customer terminal 110, a lead sales application 120, and a lead management server 130.

The lead sales application 120 may register a lead, which is business opportunity information related to a product or service for a customer, in the lead management server 130, based on an external input from a lead seller 150.

The lead seller 150 may be a salesperson who mainly handles a certain product or service, who may identify the customer's possible purchase needs (e.g., business opportunity information, i.e., lead) for other products or services other than the product or service he/she mainly handles during some business activities such as consulting with customers. The lead seller 150 who has identified such a lead may share the lead through the business opportunity information sales system 100 to provide a business opportunity to another salesperson (e.g., a lead purchaser 160) who mainly handles the other product or service.

It will be apparently understood to those skilled in the art that the lead may include at least one of lead type, detailed information for each lead type, customer name, customer age, customer gender, customer marital status, customer address, customer phone number, customer's desired contact time, customer budget, customer's purchase intention level, or customer's expected purchase time, but the disclosure is not limited thereto and may further include other business opportunity information. It will be apparently understood to those skilled in the art that the lead type may include, but is not limited to, vehicle purchase, real estate purchase, vehicle rental, real estate rental, insurance purchase, or the like, and may further include various transaction types for various products or services. The detailed information for each lead type may include detailed information on various transaction types for the product or service. For example, when the lead type is a vehicle purchase, the detailed information for each lead type may include used car or new car information, domestic or foreign car information, or the like. The customer purchase intention level may indicate the degree of the customer's purchase intention for the lead-related product or service determined by the lead seller 150. It will be apparent to those skilled in the art that the customer purchase intention level may be expressed by dividing it into certain steps, but the disclosure is not limited thereto and may be expressed in various ways.

The lead management server 130 may register the lead obtained from the lead sales application 120 in the database. The lead management server 130 may provide the lead sales application 120 with at least one predetermined lead in the database so as to output the same to the lead purchaser 160. The at least one predetermined lead may include at least one of a lead matched based on at least one information of the lead and at least one information of the predetermined lead purchaser or a lead classified based on the at least one information of the lead. The lead purchaser information may include at least one of name, photo, age, area of activity, field of expertise, field of seller qualification, area of interest, whether or not to be commissioned, the number of customers, other qualifications, activity information on business opportunity information sales system, information on lead purchase history, or popularity through purchase lead feedback. The activity information on business opportunity information sales system may include the number of times of using the lead sales application 120 for a predetermined period (e.g., a day), a lead search history, and a lead inquiry time.

The lead sales application 120 may receive a purchase request for a purchase lead amongst at least one predetermined lead provided from the lead management server 130, from the lead purchaser 160. As such, the lead purchaser 160 may attempt to purchase the purchase lead and sell the corresponding product or service to the customer secured through the purchase lead. When the sale of the product or service related to the purchase lead is completed, the lead sales application 120 may receive sell completion of the product or service related to the purchase lead, from the lead purchaser 160.

In the process of registering the lead in the lead management server 130, the customer terminal 110 may receive a consent for registration of personal information of the customer, based on an external input from the customer 140, receive approval for registration of the lead, and receive a sell confirmation when the selling of the product or service related to the purchase lead is completed.

The lead management server 130 may obtain the sell confirmation from the customer terminal 110 when the selling of the product or service related to the purchase lead is completed, and register the sell confirmation for the purchase lead in the lead management server 130.

As described above, the business opportunity information sales system 100 may be configured to perform a process of registering the lead from the lead seller 150, a process of purchasing a specific lead (e.g., purchase lead) by the lead purchaser 160, and a process of completing and confirming selling of a corresponding product or service to a customer related to the purchase lead.

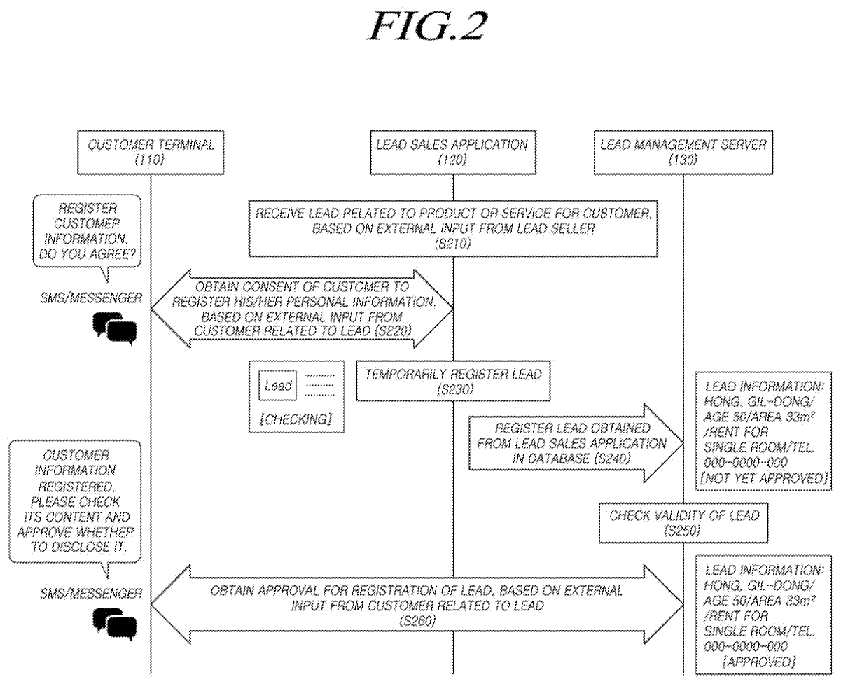

Hereinafter, description will be made to a procedure in which the business opportunity information sales system 100 performs each process in more detail with reference to FIGS. 2 to 4.

FIG. 2 schematically illustrates a procedure of obtaining and registering a lead from a lead seller according to a method of selling business opportunity information according to an embodiment of the disclosure.

A main procedure of obtaining and registering a lead from the lead seller 150 may reside in obtaining a consent for registration of the customer's personal information from the customer related the lead. As the business opportunity information expressed as a lead may correspond to the customer's personal information, the customer's consent is obtained before registering the business opportunity information in the business opportunity information sales system 100.

In operation S210, the lead sales application 120 may receive a lead related to a product or service for the customer, based on an external input from the lead seller 150.

In operation S220, the lead sales application 120 may obtain a consent of the customer to register his/her personal information from the customer terminal 110, based on an external input from the customer related to the lead. More specifically, the lead sales application 120 may request the customer terminal 110 to agree to registration of the customer's personal information registration. It will be apparent to those skilled in the art that although the present embodiment requests the customer terminal 110 to agree to registration of the customer's personal information by using an SMS or a messenger, the present embodiment is not limited thereto and various communication schemes may be used. The customer terminal 110 may receive a consent for registration of the customer's personal information, based on an external input from the customer 140, and transmit the consent information to the lead sales application 120.

In step S230, the lead sales application 120 may temporarily register the lead.

In step S240, the lead sales application 120 may request the lead management server 130 to register the temporarily registered lead.

In step S250, the lead management server 130 may check validity of the lead. The validity checks may at least identify whether the lead is prepared in compliance with a predetermined form, but it will be apparent to those skilled in the art that the disclosure is not limited thereto.

In step S260, the lead management server 130 may obtain an approval for registration of the lead, based on an external input from the customer 140 related to the lead. More specifically, the lead management server 130 may request the customer terminal 110 to confirm the content of the lead and to approve whether to disclose the lead. In the present embodiment, it will be apparent to those skilled in the art that although the customer terminal 110 is requested to confirm the content of the lead and approve whether to disclose the lead, by using SMS or messenger, various communication schemes may be used without limitation thereto. The customer terminal 110 may receive the approval on whether to disclose the lead (acquisition of approval for registration), based on an external input from the customer 140, and transmit the approval for registration to the lead management server 130.

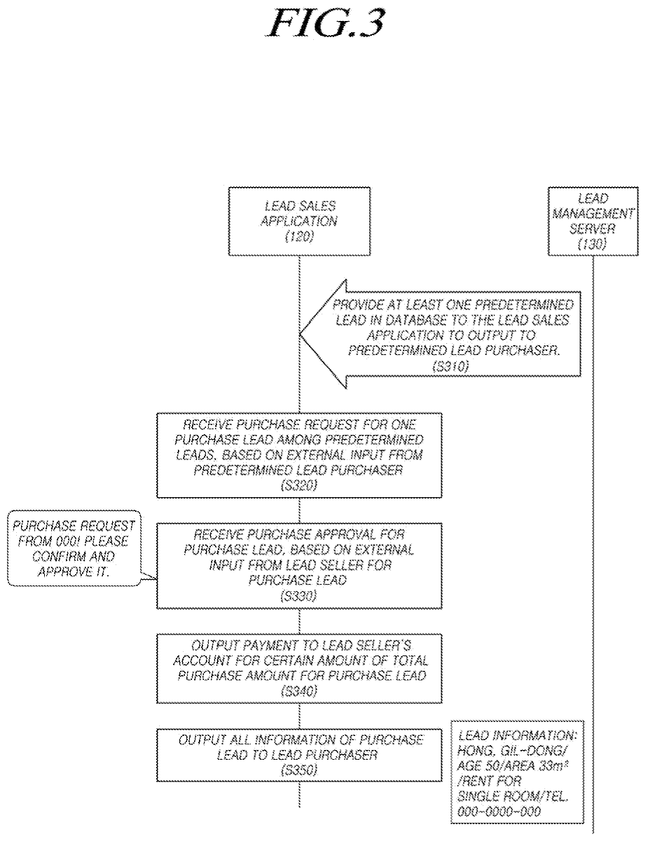

FIG. 3 schematically illustrates a procedure of purchasing a lead by a lead purchaser according to a method of selling business opportunity information according to an embodiment of the disclosure.

The main procedure in which the lead purchaser 160 purchases a specific lead (purchase lead) may be to share and purchase the purchase lead information so as to provide a business opportunity to any optimal salesperson specifically related to the purchase lead.

In operation S310, the lead management server 130 may provide at least one predetermined lead in the database to the lead sales application 120 so as to be output to a predetermined lead purchaser.

The at least one predetermined lead may include at least one of a lead matched based on at least one information of the lead and at least one information of the predetermined lead purchaser or a lead classified based on the at least one information of the lead. It will be apparent to those having ordinary knowledge in the art that there may be various algorithms for matching the at least one lead based on the at least one information of the lead and the at least one information of the predetermined lead purchaser. According to this embodiment, the lead management server 130 may further provide, to the lead sales application 120, a lead price for the at least one predetermined lead and an expected purchase rate of a product or service of the customer for the predetermined lead purchaser. The lead price may refer to a price obtained based on adding to the value of the business opportunity information represented by the lead. It will be apparent to those skilled in the art that the algorithms for determining the lead pricing and expected purchase rate may vary.

In operation S320, the lead sales application 120 may receive a purchase request for a purchase lead amongst at least one predetermined lead, based on an external input from a predetermined lead purchaser. It will be apparent to those skilled in the art that the goods input at the time of receiving the purchase request may include money and points, but are not limited thereto and various types of goods are possible.

In operation S330, the lead sales application 120 may receive a purchase approval for the purchase lead, based on an external input from the lead seller for the purchase lead.

In operation S340, the lead sales application 120 may output payment to the lead seller's account for a predetermined amount of the purchase amount for the purchase lead (settlement of the purchase amount). It will be apparent to those skilled in the art that the record of settling the purchase amount in the lead seller's account may be managed through the lead management server 130 or another server.

In step S350, the lead sales application 120 may output all information about the purchase lead to a predetermined lead purchaser. The lead purchaser may attempt to sell the corresponding product or service to the customer obtained through the purchase lead.

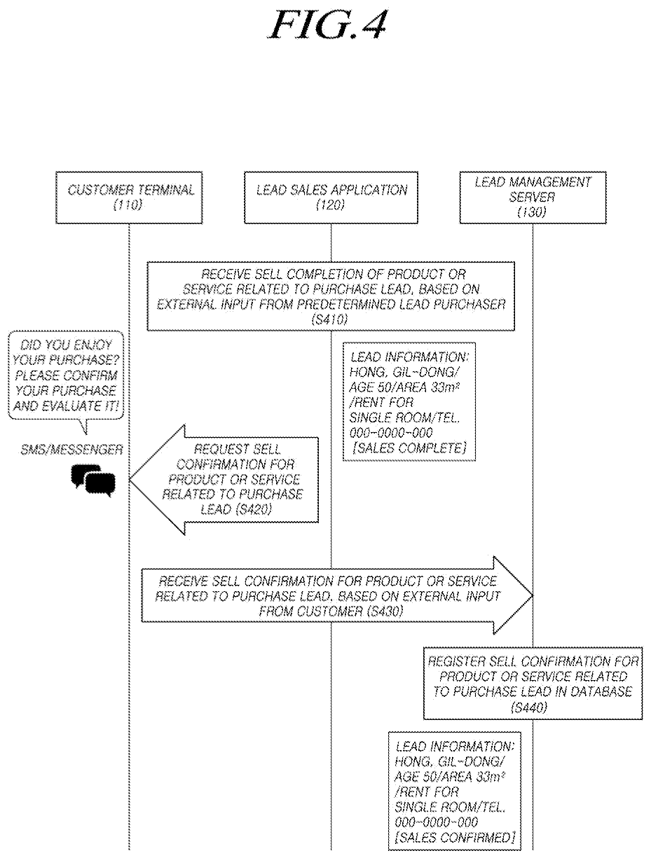

FIG. 4 schematically illustrates a procedure of completing and confirming selling of a corresponding product or service to a customer related to a purchase lead according to a method of selling business opportunity information according to an embodiment of the disclosure.

The main procedure for completing and confirming the selling of the corresponding product or service to the customer related to the purchase lead may be to confirm the selling by receiving feedback from the customer for the lead for which selling of the product or service has been completed to confirm whether the selling was made normally and successfully. In this procedure, the customer may evaluate at least one of the lead purchaser 160, the lead seller 150, and the sold product or service, and the corresponding evaluation information may be further utilized as a means of evaluating the capability and reliability of the lead purchaser 160 and the lead seller 150 later on.

When a predetermined lead purchaser has completed the selling of the product or service related to the purchase lead, in operation S410, the lead sales application 120 may receive a completion of the selling of the product or service related to the purchase lead, based on an external input from the predetermined lead purchaser.

In step S420, the lead sales application 120 may request the customer terminal 110 to confirm the selling of the product or service related to the purchase lead. It will be apparent to those skilled in the art that the present embodiment requests the customer terminal 110 to confirm the selling, using an SMS or a messenger, but the disclosure is not limited thereto and various communication schemes may be used. The customer terminal 110 may receive a sell confirmation, based on an external input from the customer, and transmit the sell confirmation to the lead management server 130. Inputting of the sell confirmation and transmitting to the lead management server 130 may be performed via a predetermined uniform resource locator (URL) included in the sell confirmation request message, but the disclosure is not limited thereto. The sell confirmation may further include at least one of evaluation information on the product or service related to the purchase lead, evaluation information on the predetermined lead purchaser, and evaluation information on the lead seller for the purchase lead.

In operation S430, the lead management server 130 may obtain from the customer terminal 110 the sell confirmation for the product or service related to the purchase lead, based on an external input from the customer.

In step S440, the lead management server 130 may register the sell confirmation for the product or service related to the purchase lead in the database.

Using the sell confirmation information registered in the database of the lead management server 130 makes it possible to provide an advanced service for a lead, a lead seller, and a lead purchaser in a later stage. For example, the matching/recommendation algorithm may be more advanced to provide the corresponding service, so that more leads are matched/recommended by the lead management server 130 for lead buyers with relatively higher reliability, based on the evaluation information for the predetermined lead buyer.

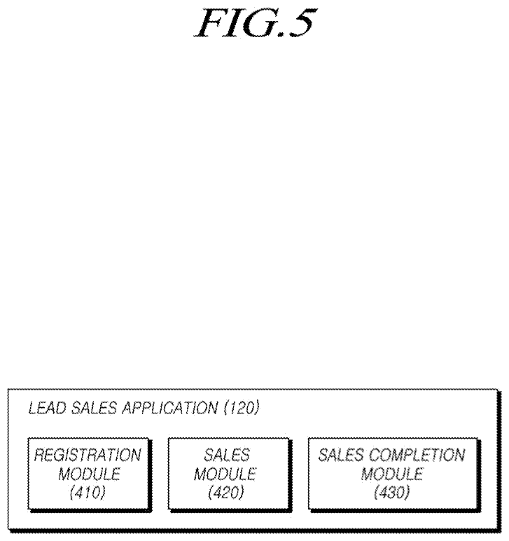

FIG. 5 is a schematic block diagram of a lead sales application according to an embodiment of the disclosure.

The lead sales application 120 according to an embodiment of the disclosure includes a registration module 410, a sales module 420, and a sales completion module 430.

The registration module 410 may receive the lead related to a product or service for a customer, based on an external input from a lead seller, and obtain consent for registration of the personal information of the customer from the customer terminal 110, based on an external input from the customer related to the lead. The registration module 410 may temporarily register the lead in the lead sales application 120. The registration module 410 may register the lead in the lead management server 130. The lead may include at least one of lead type, detailed information for each lead type, customer name, customer age, customer gender, customer's marital status, customer address, customer phone number, desired contact time for customer, customer's budget, purchase intention level of customer, or expected purchase time of customer.

The sales module 420 may receive a purchase request for a purchase lead of at least one predetermined lead provided from the lead management server 130, based on an external input from a predetermined lead purchaser. The at least one predetermined lead may include at least one of a lead matched by the lead management server 130 based on at least one information of the lead and at least one information of the predetermined lead purchaser, or a lead classified by the lead management server 130 based on the at least one information of the lead. The lead purchaser information may include at least one of customer name, photo, age, area of activity, field of expertise, field of seller qualification, area of interest, whether or not to be commissioned, the number of customers held, other qualifications, activity information on business opportunity information sales system, information on lead purchase history, or popularity through purchase lead feedback. The activity information on business opportunity information sales system may include the number of times of using the lead sales application 120 for a predetermined period (e.g., a day), a lead search history, and a lead inquiry time.

The sales module 420 may receive purchase approval for the purchase lead, based on an external input from the lead seller for the purchase lead, output payment of a predetermined amount of a purchase amount for the purchase lead to the lead seller account, and output all information on the purchase lead to the predetermined lead purchaser.

The sales completion module 430 may receive a sell completion of the product or service related to the purchase lead, based on an external input from the predetermined lead purchaser, and request the customer terminal 110 to confirm selling of the product or service related to the purchase lead. The sell confirmation may further include at least one of evaluation information on the product or service related to the purchase lead, evaluation information on the predetermined lead purchaser, and evaluation information on the lead seller for the purchase lead.

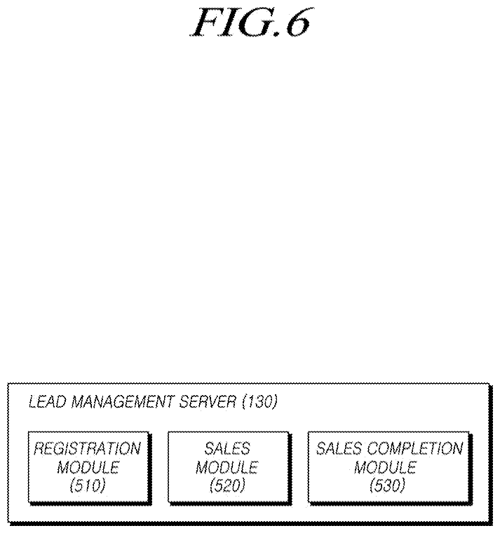

FIG. 6 is a schematic block diagram of a lead management server according to an embodiment of the disclosure.

A lead management server 130 according to an embodiment of the disclosure includes a registration module 510, a sales module 520, and a sales completion module 530.

The registration module 510 may register the lead obtained from the lead sales application 120 in a database. More specifically, the registration module 510 may check validity of the lead obtained from the lead sales application 120 and register the lead in the database by obtaining approval for registration of the lead from the customer terminal 110, based on an external input from the customer related to the lead.

The sales module 520 may provide at least one predetermined lead in the database to the lead sales application 120 to output the same to a predetermined lead purchaser. The sales module 520 may further provide a lead price for the at least one predetermined lead and an expected purchase rate of a product or service of the customer for the predetermined lead purchaser, to the lead sales application 120.

The sales completion module 530 may obtain a sell confirmation for the product or service related to the purchase lead from the customer terminal 110, based on an external input from the customer, and register the sell confirmation for the product or service related to the purchase lead in the database.

While preferred embodiments of the disclosure have been described in detail heretofore, the scope of the present invention is not limited thereto, and various modifications and equivalent other embodiments are possible. Therefore, the true technical scope of protection of the present invention will be defined by the appended claims.

For example, a device according to an example embodiment of the disclosure may include a bus coupled to units of each apparatus or device as illustrated, at least one processor operatively coupled to the bus, and a memory coupled to the bus to store instructions, received messages, or generated messages, and coupled to the at least one processor to perform the aforementioned instructions.

Further, a system according to the present invention may be implemented with computer-readable codes on a computer-readable recording medium. The computer-readable recording medium may include any kinds of recording devices in which data readable by a computer system is stored. The computer-readable recording medium may include a magnetic storage medium (e.g., ROM, floppy disk, hard disk, etc.) and an optical reading medium (e.g., CD-ROM, DVD, etc.). The computer-readable recording medium may be distributed over a network-connected computer system to store and execute computer-readable codes in a distributed manner.

1. A method for selling business opportunity information, comprising:
temporarily registering, by a lead sales application, a lead, which is business opportunity information related to a product or service for a customer, based on an external input from a lead seller;
registering, by a lead management server, the lead obtained from the lead sales application in a database;
providing, by the lead management server, at least one predetermined lead in the database to the lead sales application so as to be output to a predetermined lead purchaser; and
receiving, by the lead sales application, a purchase request for a purchase lead of the at least one predetermined lead, based on an external input from the predetermined lead purchaser.

2. The method of claim 1, wherein the lead includes at least one information of lead type, detailed information for each lead type, customer name, customer age, customer gender, customer marital status, customer address, customer phone number, customer desired contact time, customer budget, customer purchase intention level, or customer expected purchase time.

3. The method of claim 1, further comprising:
receiving, by the lead sales application, sell completion of the product or service related to the purchase lead, based on an external input from the predetermined lead purchaser;
requesting, by the lead sales application, a customer terminal to confirm selling of the product or service related to the purchase lead;
obtaining, by the lead management server, sell confirmation of the product or service related to the purchase lead from the customer terminal, based on an external input from the customer; and
registering, by the lead management server, the sell confirmation for the product or service related to the purchase lead, in the database.

4. The method of claim 1, wherein temporarily registering the lead includes:
receiving, by the lead sales application, the lead related to the product or service for the customer, based on an external input from the lead seller; and
obtaining, by the lead sales application, consent for personal information registration of the customer from the customer terminal, based on an external input from the customer related to the lead.

5. The method of claim 1, wherein registering the lead in the database includes:
identifying validity of the lead; and
obtaining registration approval for the lead from a customer terminal, based on an external input from the customer related to the lead.

6. The method of claim 1, wherein the at least one predetermined lead includes at least one of a lead matched based on at least one information of the lead and at least one information of the predetermined lead purchaser or a lead classified based on the at least one information of the lead.

7. The method of claim 1, wherein providing the at least one predetermined lead in the database to the lead sales application includes further providing a lead price for the at least one predetermined lead and an expected purchase rate of a product or service of a customer for the predetermined lead purchaser, to the lead sales application.

8. The method of claim 1, further comprising completing, by the lead sales application, the purchase for the purchase request,
wherein completing the purchase includes:
receiving, by the lead sales application, purchase approval for the purchase lead, based on an external input from the lead seller for the purchase lead;
outputting, by the lead sales application, payment of a certain amount of a purchase amount for the purchase lead to a lead seller account; and
outputting entire information on the purchase lead to the predetermined lead purchaser.

9. The method of claim 3, wherein the sell confirmation further includes at least one of evaluation information on the product or service related to the purchase lead, evaluation information on the predetermined lead purchaser, or evaluation information on the lead seller for the purchase lead.

10. A computer-readable recording medium having recorded thereon a program for performing the method according to claim 1.

11. A business opportunity information sales system, comprising:
a lead sales application including a registration module for temporarily registering a lead, which is business opportunity information related to a product or a service for a customer, based on an external input from a lead seller, and a sales module for receiving a purchase request for a purchase lead of at least one predetermined lead provided from a lead management server, based on an external input from a predetermined lead purchaser; and
the lead management server including a registration module for registering the lead obtained from the lead sales application in a database, and a sales module for providing the at least one predetermined lead in the database to the lead sales application so as to output the lead to the predetermined lead purchaser.

12. The business opportunity information sales system of claim 11, wherein the lead sales application further includes a sales completion module for receiving a sell completion for the product or service related to the purchase lead, based on an external input from the predetermined lead purchaser and for requesting a sell confirmation for the product or service related to the purchase lead from a customer terminal, and
wherein the lead management server further includes a sales completion module for obtaining the sell confirmation for the product or service related to the purchase lead from the customer terminal, based on an external input from the customer and for registering the sell confirmation for the product or service related to the purchase lead in the database.

13. The business opportunity information sales system of claim 11, wherein the registration module of the lead sales application receives the lead related to the product or service for the customer, based on an external input from the lead seller, and obtains consent for personal information registration of the customer from the customer terminal, based on an external input from the customer related to the lead.

14. The business opportunity information sales system of claim 11, wherein the registration module of the lead management server checks validity of the lead, and obtains registration approval for the lead from the customer terminal, based on an external input from the customer related the lead.

15. The business opportunity information sales system of claim 11, wherein the at least one predetermined lead includes at least one of a lead matched based on at least one information of the lead and at least one information of the predetermined lead purchaser, or a lead classified based on the at least one information of the lead.
